(19) United States
(12) Patent Application Publication
(10) Pub. No.: US 2026/0341084 A1
(43) Pub. Date: Oct. 29, 2026

(54) APPARATUS AND METHOD FOR DIAGNOSING A BATTERY

(71) Applicants: HYUNDAI MOTOR COMPANY, Seoul (KR); KIA CORPORATION, Seoul (KR)

(72) Inventors: Jae Won Kim, Hwaseong-si (KR); Hyo Kyung Lee, Hwaseong-si (KR); Yoon Sung Choi, Hwaseong-si (KR)

(73) Assignees: HYUNDAI MOTOR COMPANY, Seoul (KR); KIA CORPORATION, Seoul (KR)

(21) Appl. No.: 19/318,135

(22) Filed: Sep. 3, 2025

(30) Foreign Application Priority Data
Apr. 28, 2025 (KR) 10-2025-0055685

(51) Int. Cl. G07C 5/08; G06N 3/0455; G07C 5/04; H01M 10/42

(52) U.S. Cl. CPC G07C 5/0808; G06N 3/0455; G07C 5/04; H01M 10/4285; H01M 2220/20

(57) ABSTRACT

Disclosed are a battery diagnosing apparatus and a method thereof. The battery diagnosing apparatus includes a communication device that receives time-series data associated with a condition of a battery from a vehicle, and a controller that divides the time-series data into unit window blocks, divides time-series data included in respective unit window blocks into data segments associated with operating states of the vehicle, inputs the data segments into an artificial intelligence model trained to classify the data segments as normal or abnormal, and diagnoses whether the battery is abnormal based on classification of the data segments by the artificial intelligence model.

### CROSS-REFERENCE TO RELATED APPLICATION

This application claims the benefit of and priority to Korean Patent Application No. 10-2025-0055685, filed in the Korean Intellectual Property Office on Apr. 28, 2025, the entire contents of which are hereby incorporated herein by reference.

### TECHNICAL FIELD

The present disclosure relates to a battery diagnosing apparatus and a battery diagnosing method.

### BACKGROUND

Batteries play a key role in storing and releasing electrical energy between the anode and cathode. Batteries are utilized, for example, as a core energy source in various fields such as electric vehicles (EVs) and energy storage systems (ESS).

Accordingly, the importance of the Battery Management System (BMS), which ensures the performance and safety of batteries, is being emphasized. The BMS monitors the conditions of the batteries and performs functions such as charge/discharge control, cell balancing, and temperature management to ensure efficient operation and safety of the batteries.

However, as an in-vehicle controller, the BMS is limited in terms of computing performance and storage capacity, making it difficult to run advanced data analysis and battery diagnostic algorithms. In particular, continuously storing long-term time-series data on the battery and running diagnostic algorithms on all time-series data may be inefficient and may exceed a vehicle's computational and storage limits.

To solve the issues, technologies that transmit battery data to a server to perform AI-based analysis and diagnosis are gaining attention. This approach not only reduces the computational burden on the BMS but also performs precise battery state analysis and anomaly detection by utilizing the powerful computing resources of the server.

The statements in this Background section merely provide background information related to the present disclosure and do not necessarily constitute prior art.

### SUMMARY

The present disclosure was made to solve the above-mentioned problems occurring in the prior art while advantages achieved by the prior art are maintained intact.

Embodiments of the present disclosure perform efficient and accurate server-based battery diagnostics.

Aspects of the present disclosure provide a battery diagnosing apparatus and method that communicate with BMS to perform cloud-based battery diagnostics.

Aspects of the present disclosure provide a battery diagnosing apparatus and method that diagnose whether a battery is abnormal, via an auto encoder-based artificial intelligence model.

Aspects of the present disclosure provide a battery diagnosing apparatus and method that diagnose whether a battery is abnormal, based on an artificial intelligence model in a cloud if the BMS determines that a battery diagnosis is necessary.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a battery diagnosing apparatus is provided. The battery diagnosing apparatus includes a communication device configured to receive time-series data associated with a condition of a battery from a vehicle. The battery diagnosing apparatus also includes a controller configured to divide the time-series data into unit window blocks. The controller is also configured to divide time-series data included in respective unit window blocks, among the unit window blocks, into data segments associated with operating states of the vehicle. The controller is further configured to input the data segments into an artificial intelligence model trained to classify the data segments as normal or abnormal. The controller is additionally configured to diagnose whether the battery is abnormal, based on classification the data segments by the artificial intelligence model.

According to an embodiment, each data segment, among the data segments, may correspond to one of a driving state, a state of charge (SOC), or a parking state of the vehicle.

According to an embodiment, the controller may diagnose that the battery is abnormal based on at least one of the data segments being classified as abnormal by the artificial intelligence model.

According to an embodiment, the artificial intelligence model may include an auto-encoder-based model. The artificial intelligence model may be configured to determine a reconstruction error of each of the data segments that is input to the artificial intelligence model. The artificial intelligence model may be configured to classify a data segment, among the data segments, as abnormal based on determining that the reconstruction error for the data segment exceeds a predetermined reference value.

According to an embodiment, the battery diagnosing apparatus may further include a learning device configured to learn the artificial intelligence model by using segment data classified as normal among data segments used as learning data.

According to an embodiment, the learning device may be configured to adjust the predetermined reference value based on the reconstruction error of the data segment classified as normal.

According to an embodiment, the learning device may be configured to evaluate performance of the artificial intelligence model by using, as verification data, data segments classified as abnormal among the data segments used as the learning data.

According to an embodiment, the learning device may be configured to evaluate the performance of the artificial intelligence model by further using, as the verification data, a certain ratio of the data segments classified as normal among the data segments used as the learning data.

According to an embodiment, the controller may be configured to store classification results of the data segments and a result of evaluating performance of the artificial intelligence model in a database.

According to another aspect of the present disclosure, a battery diagnosing method is provided. The battery diagnosing method includes obtaining time-series data associated with a condition of a battery from a vehicle. The battery diagnosing method also includes dividing the time-series data into unit window blocks. The battery diagnosing method also includes dividing time-series data included in respective unit window blocks, among the unit window blocks, into data segments associated with operating states of the vehicle. The battery diagnosing method additionally includes inputting the data segments into an artificial intelligence model trained to classifying the data segments as normal or abnormal. The battery diagnosing method further includes diagnosing whether the battery is abnormal, based on classification of the data segments by the artificial intelligence model.

According to an embodiment, each of the data segments may correspond to one of a driving state, an SOC, or a parking state of the vehicle.

According to an embodiment, diagnosing whether the battery is abnormal may include diagnosing that the battery is abnormal based on at least one of the data segments being classified as abnormal by the artificial intelligence model.

According to an embodiment, the method may further include determining a reconstruction error of each of the data segments that is input to the artificial intelligence model, and classifying a data segment, among the data segments, as abnormal based on determining that the reconstruction error exceeds a predetermined reference value.

According to an embodiment, the method may further include learning the artificial intelligence model by using data segments classified as normal among data segments used as learning data.

According to an embodiment, the method may further include adjusting the predetermined reference value based on the reconstruction error of the data segment classified as normal.

According to an embodiment, the method may further include evaluating performance of the artificial intelligence model by using, as verification data, segment data classified as abnormal among the data segments used as learning data.

According to an embodiment, evaluating the performance of the artificial intelligence model may include evaluating the performance of the artificial intelligence model by further using, as the verification data, a certain ratio of the data segments classified as normal among the data segments used as learning data.

According to an embodiment, the method may further include storing classification results of the data segments and a result of evaluating performance of the artificial intelligence model in a database.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram illustrating a battery diagnosing system, according to an embodiment of the present disclosure;

FIG. 2 is a block diagram showing a configuration of a battery diagnosing apparatus, according to an embodiment of the present disclosure;

FIG. 3 is a diagram for describing window division of time-series data, according to an embodiment of the present disclosure;

FIG. 4 is a diagram for describing an artificial intelligence model, according to an embodiment of the present disclosure;

FIG. 5 is a graph showing a reconstruction error of segment data, according to an embodiment of the present disclosure;

FIGS. 6 to 8 are flowcharts for describing a battery diagnosing method, according to an embodiment of the present disclosure; and

FIG. 9 is a block diagram illustrating a computing system for performing a battery diagnosing method, according to an embodiment of the present disclosure.

### DETAILED DESCRIPTION

Hereinafter, various embodiments of the present disclosure are described in detail with reference to the accompanying drawings. For the sake of clarity in the present disclosure, portions not associated with descriptions have been omitted. Further, the same reference numerals refer to the same or similar components throughout the present disclosure, and redundant descriptions thereof have been omitted.

Furthermore, various embodiments of the present disclosure may be implemented in a variety of forms and should not be construed as being limited to the embodiments described in the present disclosure. Embodiments of the present disclosure and terms used herein are not intended to limit the technical features described in the present disclosure to specific embodiments. Rather, it should be understood that the embodiments and the terms include modifications, equivalents, or alternatives.

To describe components of embodiments of the present disclosure, terms such as first, second, A, B, (a), (b), etc., may be used. These terms are merely used to distinguish one component from another component. These terms do not limit the corresponding components irrespective of the nature or priority of the corresponding components. Furthermore, unless otherwise defined, all terms used in the present disclosure, including technical or scientific terms, include the same meaning as commonly understood by one of ordinary skill in the art to which the present disclosure pertains. The terms or words used in the present disclosure should not be interpreted as being limited to ordinary or dictionary meanings. Rather, the terms or words should be interpreted in accordance with the technical spirit and concept of the present disclosure.

According to embodiments of the present disclosure, each component may include a single entity or a plurality of entities, and some of a plurality of objects may be separately placed on other components. According to various embodiments, one or more of the described components or steps may be omitted and/or one or more other components or operations may be added. Moreover, according to various embodiments, a plurality of components may be integrated into a single component. In this case, the integrated component may perform one or more functions of each component of the plurality of components in the manner same as or similar to being performed by the corresponding component of the plurality of components prior to the integration. According to various embodiments of the present disclosure, operations executed by modules, programs, or other components may be executed by a successive method, a parallel method, or a repeated method. Alternatively, at least one of operations may be executed in another order or one or more other operations may be added.

When a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, or the like may separately embody or be included with one or more processors and a memory, such as a non-transitory computer-readable media, as part of the apparatus. The one or more processors may be configured to implement computer-readable instructions stored in the memory to perform the described operations.

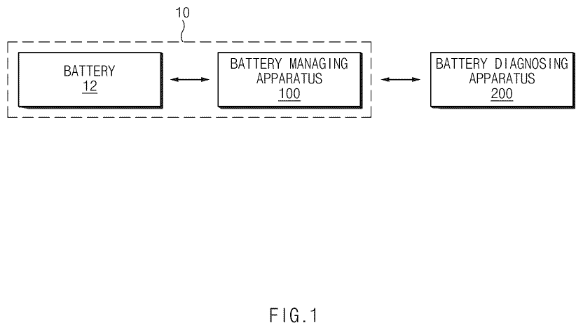

Hereinafter, embodiments of the present disclosure are described in detail with reference to FIGS. 1-10.

FIG. 1 is a block diagram illustrating a battery diagnosing system, according to an embodiment of the present disclosure.

Referring to FIG. 1, a battery diagnosing system according to an embodiment may include a battery 12, a battery managing apparatus 100, and a battery diagnosing apparatus 200. According to various embodiments, the battery 12 and the battery managing apparatus 100 may be implemented or otherwise in a vehicle 10, and the battery diagnosing apparatus 200 may be implemented or otherwise provided outside the vehicle 10.

According to an embodiment, the battery 12 may be included in the vehicle 10 and may include a plurality of battery cells. For example, the battery 12 may include a plurality of battery cells connected in series or parallel with each other.

According to an embodiment, the battery managing apparatus 100 may be included in the vehicle 10 and may be implemented as a BMS.

According to an embodiment, the battery managing apparatus 100 may obtain time-series data of the battery 12 by monitoring the battery 12. The time-series data may refer to condition data of the battery 12 acquired at regular time intervals. The time-series data may include current, voltage, temperature, state of charge (SOC), and/or state of health (SOH) of the battery 12.

According to an embodiment, the battery managing apparatus 100 may determine whether abnormal diagnosis by the battery diagnosing apparatus 200 is required. The battery managing apparatus 100 may determine whether abnormal diagnosis by the battery diagnosing apparatus 200 is necessary, based on whether a predetermined criterion is satisfied, by analyzing time-series data.

For example, the battery managing apparatus 100 may obtain voltage data of the plurality of battery cells. If a difference between the maximum voltage value and the minimum voltage value is greater than a reference value, the battery managing apparatus 100 may determine that abnormal diagnosis by the battery diagnosing apparatus 200 is required. As another example, if there is data with the reference value or more among the temperature data of the battery 12, the battery managing apparatus 100 may determine that abnormal diagnosis by the battery diagnosing apparatus 200 is required.

According to an embodiment, the battery managing apparatus 100 may transmit the time-series data to the battery diagnosing apparatus 200. The battery managing apparatus 100 may transmit the time-series data to the battery diagnosing apparatus 200 by wired or wireless communication. In an embodiment, the battery managing apparatus 100 may transmit the time-series data to the battery diagnosing apparatus 200 via a communication device (not shown) included in the vehicle 10.

According to an embodiment, based on determining that abnormal diagnosis by the battery diagnosing apparatus 200 is necessary, the battery managing apparatus 100 may transmit the time-series data for abnormal diagnosis to the battery diagnosing apparatus 200. Also, the battery managing apparatus 100 may transmit the time-series data for learning and/or verifying an artificial intelligence model to the battery diagnosing apparatus 200.

According to an embodiment, the battery diagnosing apparatus 200 may acquire the time-series data associated with the condition of the battery 12 and may perform operations of diagnosing whether the battery 12 is abnormal. The battery diagnosing apparatus 200 may be implemented in the form of a server or cloud. Moreover, the battery diagnosing apparatus 200 may obtain the time-series data associated with the condition of the battery 12 from the vehicle 10. For example, the battery diagnosing apparatus 200 may obtain the time-series data from a communication device (not shown) included in the vehicle 10 or the battery managing apparatus 100.

According to an embodiment, the battery diagnosing apparatus 200 may learn and/or verify an artificial intelligence model by using the time-series data associated with the condition of the battery 12 as learning data and/or verification data. The battery diagnosing apparatus 200 may learn the artificial intelligence model by using normal data from time-series data as training data and may verify the artificial intelligence model by using abnormal data as verification data. Furthermore, the battery diagnosing apparatus 200 may evaluate the performance of the artificial intelligence model and may update the artificial intelligence model if the performance is improved.

According to an embodiment, the battery diagnosing apparatus 200 may obtain the time-series data associated with the condition of the battery from the vehicle 10 and may perform abnormal diagnosis based on the artificial intelligence model. In an embodiment in which the battery diagnosing apparatus 200 is implemented in the form of a cloud, the battery diagnosing apparatus 200 may diagnose whether the battery is abnormal, based on the artificial intelligence model stored in the cloud.

According to an embodiment, the battery diagnosing apparatus 200 may transmit a signal for outputting a diagnosis result and a warning notification to the vehicle 10 based on diagnosing that the battery 12 includes abnormality. For example, the battery diagnosing apparatus 200 may transmit, to the vehicle 10, a signal for outputting a battery pack replacement notification or a vehicle maintenance notification.

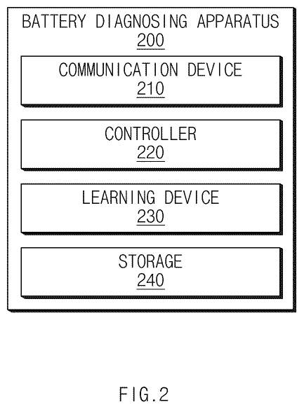

FIG. 2 is a block diagram showing a configuration of a battery diagnosing apparatus, according to an embodiment of the present disclosure.

Referring to FIG. 2, a battery diagnosing apparatus 200 according to an embodiment may include a communication device 210, a controller 220, a learning device 230, and storage 240. However, in various embodiments, the components of the battery diagnosing apparatus 200 may be combined with each other and implemented as one and/or some components may be omitted.

According to an embodiment, the communication device 210 may include a communication circuit capable of communicating with another electronic device. In an embodiment, the communication device 210 may receive time-series data from the vehicle 10 and may transmit battery diagnosis results analyzed by the controller 220 to the vehicle 10. The communication device 210 may include a mobile communication module, a wireless communication module, a short-range communication module, or the like for communication with the vehicle 10.

According to an embodiment, the controller 220 may control an operation of the battery diagnosing apparatus 200 by executing commands stored in the storage 240. For example, the controller 220 may include a processor that executes at least one instruction stored in the storage 240. In an embodiment, the controller 220 may execute an artificial intelligence model stored in the storage 240 to perform abnormal diagnosis of the battery 12 according to an embodiment of the present disclosure.

According to an embodiment, the controller 220 may split (also sometimes referred to herein as “divide”) time-series data into unit windows (also sometimes referred to herein as “unit window blocks”). The unit window blocks may refer to a time-series data block obtained by splitting the time-series data into certain time intervals. The controller 220 may split the entire time-series data acquired from the vehicle 10 into unit window blocks according to predetermined time intervals.

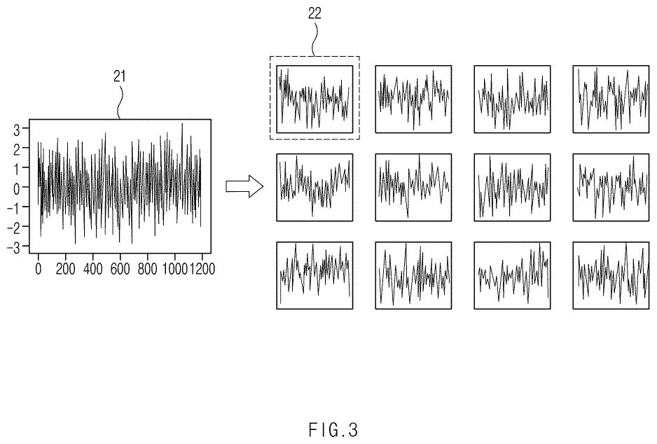

FIG. 3 is a diagram for describing window division of time-series data, according to an embodiment of the present disclosure.

Referring to FIG. 3, the battery diagnosing apparatus 200 may split time-series data 21 acquired from the vehicle 10 into unit windows 22.

For example, the controller 220 of the battery diagnosing apparatus 200 may split the time-series data 21 of 1200 seconds in length into the 12 unit windows 22 of 100 seconds in length. However, the length of the time interval by which the controller 220 splits the time-series data into unit windows is only an example, and the present disclosure is not limited thereto.

Returning to FIG. 2, the controller 220 may split the time-series data included in the unit window into pieces of segment data (sometimes also referred to herein as “data segments”) associated with an operating state of the vehicle 10. The pieces of segment data refer to a data block obtained by classifying the time-series data included in the unit window based on the operating state of the vehicle 10. Accordingly, the controller 220 may split each unit window into pieces of segment data according to the operating state of the vehicle 10.

For example, each piece of segment data may correspond to one of the driving state, the SOC, and the parking state of the vehicle 10. In an embodiment, the driving state means that the vehicle 10 is turned on while the battery managing apparatus 100 is operating. Moreover, the SOC means that a charging terminal is connected to the vehicle 10. The parking state means that the vehicle 10 is turned off while the battery managing apparatus 100 is operating.

According to an embodiment, the controller 220 may input the pieces of segment data into an artificial intelligence model learned based on the pieces of segment data to classify them as normal or abnormal. The artificial intelligence model may include an auto-encoder-based model learned based on the pieces of segment data obtained from the battery 12.

According to an embodiment, the artificial intelligence model may calculate a reconstruction error of each piece of segment data thus input, and may classify segment data as abnormal if the reconstruction error exceeds a predetermined reference value. The reconstruction error refers to a difference between data input to an auto-encoder model and data output via an encoder and a decoder. For example, the reconstruction error may be calculated by using the mean square error (MSE) of the input data and the output data.

According to an embodiment, the reference value may be set in advance based on the reconstruction error of pieces of segment data obtained from the normal battery 12. For example, the reconstruction error of the input data and the output data may be calculated by inputting normal segment data obtained from the normal battery 12 into an artificial intelligence model, and then a reference value may be set based on the distribution of the reconstruction error.

According to an embodiment, the controller 220 may diagnose whether the battery 12 is abnormal, based on the classification results of the pieces of segment data. For example, if the artificial intelligence model classifies at least one of the pieces of segment data as abnormal, the controller 220 may diagnose that the battery 12 is abnormal.

According to an embodiment, the controller 220 may store the classification results of pieces of segment data and the performance evaluation results of the artificial intelligence model by the learning device 230 in a database. Accordingly, the battery diagnosing apparatus 200 may manage a diagnosis history based on whether each segment data is abnormal, and performance information of a model without storing all pieces of time-series data.

According to an embodiment, the learning device 230 may include computing resources or modules that perform learning and verification of the artificial intelligence model. The learning device 230 may generate learning data for learning the artificial intelligence model and verification data for verifying the artificial intelligence model. The learning device 230 may learn the artificial intelligence model with the learning data and may evaluate its performance by verifying the artificial intelligence model with the verification data. If the performance is improved compared to the existing artificial intelligence model, the battery diagnosing apparatus 200 may store the additionally learned artificial intelligence model and may execute it if a battery is diagnosed as abnormal.

According to an embodiment, the learning device 230 may learn the artificial intelligence model by using segment data classified as normal among the pieces of segment data as the learning data. The learning device 230 may load segment data classified as normal from among the pieces of segment data stored in the storage 240, and may learn the artificial intelligence model by using a certain ratio of the segment data, that is classified as normal, as the learning data. For example, the learning device 230 may learn the artificial intelligence model by using 70% of the segment data classified as normal as learning data.

According to an embodiment, the learning device 230 may adjust a reference value based on the reconstruction error of segment data classified as normal. For example, the learning device 230 may set and/or adjust the reference value depending on the distribution of the reconstruction error of data classified as normal. Accordingly, the learning device 230 may optimize the reference value while additionally learning the artificial intelligence model by using segment data, which is classified as normal, as the learning data.

According to an embodiment, the learning device 230 may evaluate the performance of an artificial intelligence model by using segment data classified as abnormal among pieces of segment data as the verification data. The learning device 230 may load segment data classified as abnormal among pieces of segment data stored in the storage 240 and may evaluate the performance of the artificial intelligence model by using the segment data classified as abnormal as the verification data.

According to an embodiment, the learning device 230 may evaluate the performance of the artificial intelligence model by using a certain ratio of segment data classified as normal as the verification data. For example, the learning device 230 may evaluate the performance of the artificial intelligence model by using 30% of the segment data classified as normal as the verification data. In an embodiment, the learning device 230 may evaluate the performance of the artificial intelligence model by using a certain ratio of segment data classified as normal, and segment data classified as abnormal as the verification data.

For example, the learning device 230 may evaluate the performance of the artificial intelligence model by calculating at least one of F1 score, Area Under the Receiver Operating Characteristic curve (AUROC), or Area Under the Precision-Recall Curve (AUPRC).

According to an embodiment, the storage 240 may be a means for storing data and an algorithm according to an embodiment of the present disclosure. For example, the storage 240 may store the time-series data acquired from the vehicle 10, the artificial intelligence model, the performance evaluation results of the artificial intelligence model, past diagnosis history, and the calculation results of the controller 220. The storage 240 may store the artificial intelligence model whose performance is improved as the learning device 230 performs additional learning.

For example, in an embodiment in which the battery diagnosing apparatus 200 is implemented in a cloud form, the storage 240 may store the data and the algorithm by utilizing a distributed storage system or a cloud database accessible over a network. In this case, the storage 240 may store the time-series data acquired from the vehicle 10 in a cloud server and may manage the time-series data in conjunction with a database management system.

The battery diagnosing apparatus 200 according to an embodiment of the present disclosure may split the entire time-series data into unit windows, may split time-series data included in the unit window into pieces of segment data, and may perform abnormal diagnosis of the battery, thereby early detecting local abnormalities and performing parallel analysis.

Furthermore, the battery diagnosing apparatus 200 may perform abnormal diagnosis of a battery based on the results of classifying pieces of segment data corresponding to the operating state of the vehicle as normal or abnormal, thereby optimally analyzing the operating state of the vehicle.

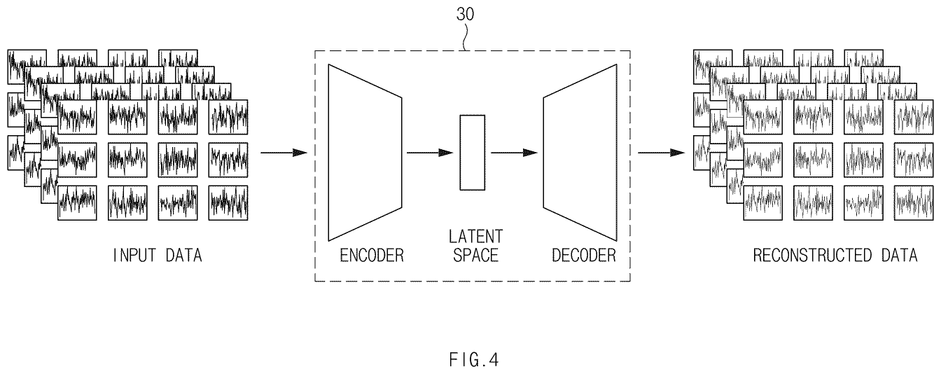

FIG. 4 is a diagram for describing an artificial intelligence model, according to an embodiment of the present disclosure.

Referring to FIG. 4, an artificial intelligence model 30 according to an embodiment may be implemented as an auto-encoder model including an encoder, a latent space, and a decoder.

The artificial intelligence model 30 may receive, as input data, a dataset consisting of pieces of segment data or time-series data split into unit windows. In FIG. 4, the artificial intelligence model 30 is shown as receiving, as input data, a dataset consisting of time-series data split into unit windows, but this is only an example. Accordingly, the artificial intelligence model 30 may receive, as input data, a dataset consisting of pieces of segment data.

If the artificial intelligence model 30 receives input data, the encoder may extract key features of the input data and may store the extracted result in the latent space. While maintaining the pattern of time-series data, the artificial intelligence model 30 may remove unnecessary noise by converting high-dimensional time-series data into low-dimensional vectors via an encoder.

The latent space refers to a vector space in which core information of input data is expressed in a compressed form. The auto-encoder model learns normal data patterns, and thus if abnormal data is input, it may include a compressed representation different from the original representation. The artificial intelligence model 30 may restore compressed data in the latent space back to its original format via a decoder. That is, if the encoder reduces the input data into a low-dimensional vector, the decoder expands it to its original format to generate reconstructed data.

The artificial intelligence model 30 may receive the input data and may then output the reconstructed data via the encoder, the latent space, and the decoder. The reconstructed data is restored via the decoder and includes a similar format to the original input data. In an embodiment, the auto-encoder model learns normal data patterns, and thus if normal data is input, it is restored with high accuracy, but if abnormal data is input, a reconstruction error increases. Accordingly, the artificial intelligence model 30 may classify input data as normal or abnormal by calculating the reconstruction error of the reconstructed data that is restored via the decoder.

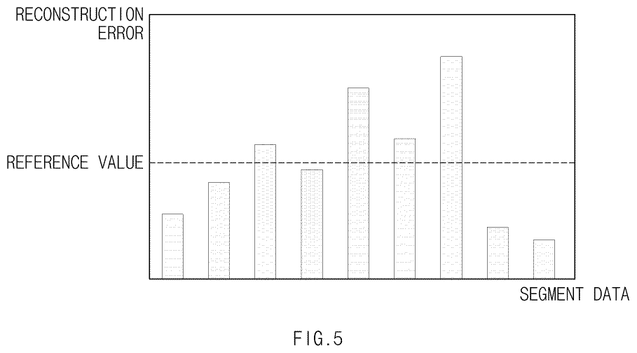

Hereinafter, the determination of whether there is an abnormality according to the reconstruction error of segment data, according to an embodiment, is described in more detail with reference to FIG. 5.

FIG. 5 is a graph showing a reconstruction error of segment data, according to an embodiment of the present disclosure.

Referring to FIG. 5, an artificial intelligence model may receive pieces of segment data, may calculate each reconstruction error, and may compare it with a predetermined reference value. In FIG. 5, a horizontal axis represents segment data and a vertical axis represents reconstruction error.

According to an embodiment, the artificial intelligence model may calculate or otherwise determine the reconstruction error of pieces of segment data by MSE of each reconstruction error of time-series data included in the pieces of segment data. For example, if first segment data includes 200 pieces of time-series data, the artificial intelligence model may calculate or otherwise determine the reconstruction error of the first segment data by the MSE of the reconstruction error of each of the 200 pieces of time-series data.

According to an embodiment, the artificial intelligence model may classify each piece of segment data as normal or abnormal by comparing the reconstruction error of each piece of segment data with the predetermined reference value. For example, the artificial intelligence model may classify each of three pieces of segment data whose reconstruction error exceeds the reference value shown in FIG. 5 as abnormal.

Accordingly, the artificial intelligence model classifies at least one of pieces of segment data as abnormal, and thus the battery diagnosing apparatus 200 may diagnose that the battery 12 is abnormal.

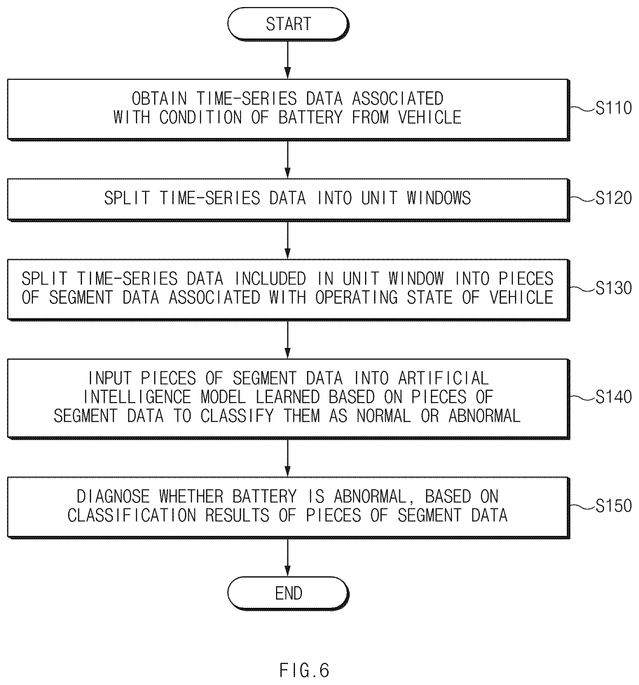

FIGS. 6-8 are flowcharts for describing a battery diagnosing method, according to an embodiment of the present disclosure. Below, it is assumed that the battery diagnosing apparatus 200 of FIGS. 1 and 2 performs each step of FIGS. 6-8. Each of the steps in FIGS. 6-8 may be performed sequentially, but is not necessarily sequentially performed. For example, the order of the steps may be changed and a plurality of steps may be performed in parallel.

Referring to FIG. 6, in an operation S110, the battery diagnosing apparatus 200 may obtain the time-series data associated with the condition of the battery 12 from the vehicle 10.

In an operation S120, the battery diagnosing apparatus 200 may split time-series data into unit windows.

In an operation S130, the battery diagnosing apparatus 200 may split the time-series data included in the unit window into pieces of segment data associated with an operating state of the vehicle 10.

For example, the battery diagnosing apparatus 200 may split the time-series data included in a unit window into pieces of segment data corresponding to one of the driving state, the SOC, and the parking state of the vehicle 10.

In an operation S140, the battery diagnosing apparatus 200 may input pieces of segment data into the artificial intelligence model learned based on the pieces of segment data to classify them as normal or abnormal.

For example, the artificial intelligence model includes an auto-encoder-based model, and determines the reconstruction error for each piece of segment data input. If the reconstruction error exceeds a predetermined reference value, the artificial intelligence model classifies it as abnormal.

In an operation S150, the battery diagnosing apparatus 200 may diagnose whether the battery 12 is abnormal, based on the classification results of the pieces of segment data.

For example, if the artificial intelligence model classifies at least one of the pieces of segment data as abnormal, the battery diagnosing apparatus 200 may diagnose that the battery 12 is abnormal.

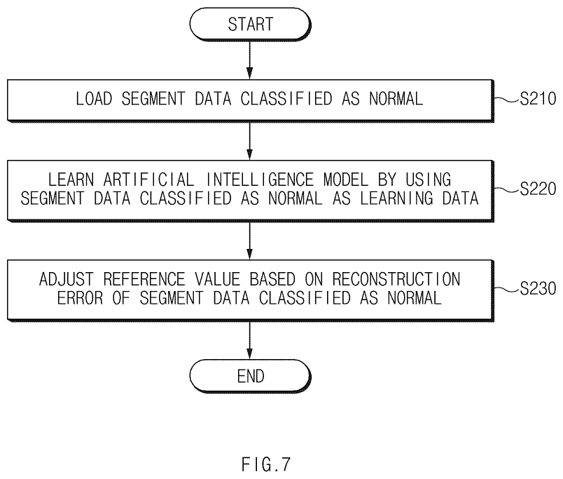

Referring to FIG. 7, in an operation S210, the battery diagnosing apparatus 200 may load segment data classified as normal to learn an artificial intelligence model.

For example, the battery diagnosing apparatus 200 may load segment data acquired from the normal battery 12, or segment data previously classified as normal by the artificial intelligence model.

In an operation S220, the battery diagnosing apparatus 200 may learn the artificial intelligence model by using segment data, that is classified as normal, as learning data.

In an operation S230, the battery diagnosing apparatus 200 may adjust a reference value based on the reconstruction error of segment data classified as normal.

For example, the battery diagnosing apparatus 200 may calculate each reconstruction error of segment data classified as normal and may adjust the reference value based on the distribution of the reconstruction error.

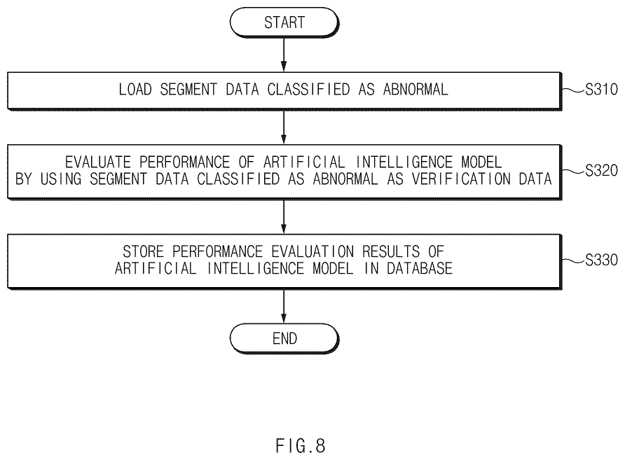

Referring to FIG. 8, in an operation S310, the battery diagnosing apparatus 200 may load segment data classified as abnormal to verify the learned artificial intelligence model.

In an operation S320, the battery diagnosing apparatus 200 may evaluate the performance of the artificial intelligence model by using segment data classified as abnormal as verification data.

For example, the battery diagnosing apparatus 200 may evaluate the performance of the artificial intelligence model by using a certain ratio of segment data classified as normal as the verification data. The battery diagnosing apparatus 200 may thus evaluate the performance of the artificial intelligence model by using a certain ratio of segment data classified as normal, and segment data classified as abnormal as the verification data.

In an operation S330, the battery diagnosing apparatus 200 may store the performance evaluation results of the artificial intelligence model in a database. For example, the battery diagnosing apparatus 200 may store the classification results of pieces of segment data and the performance evaluation results of the artificial intelligence model in a database.

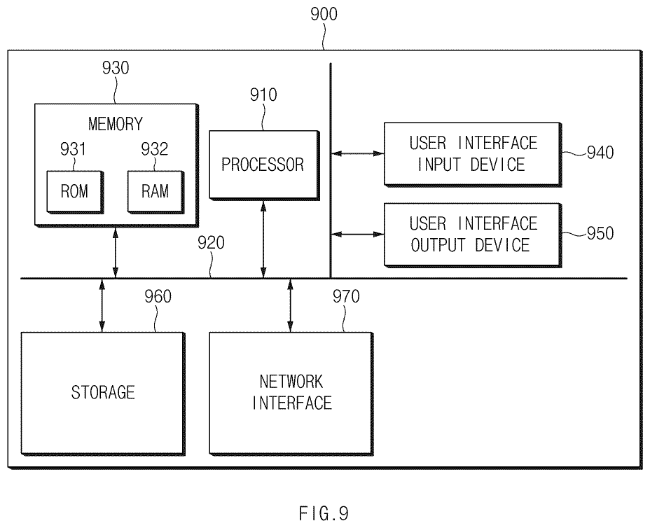

FIG. 9 is a block diagram illustrating a computing system for performing a battery diagnosing method, according to an embodiment of the present disclosure.

Referring to FIG. 9, the battery diagnosing method according to an embodiment of the present disclosure may be implemented via a computing system 900. The computing system 900 may include at least one processor 910, a memory 930, a user interface input device 940, a user interface output device 950, storage 960, and a network interface 970, which are connected with each other via a system bus 920.

The processor 910 may be a central processing unit (CPU) or a semiconductor device that processes instructions stored in the memory 930 and/or the storage 960. Each of the memory 930 and the storage 960 may include various types of volatile or nonvolatile storage media. For example, the memory 930 may include a read only memory (ROM) 931 and a random access memory (RAM) 932.

Accordingly, the operations of the method or algorithm described in connection with embodiments disclosed in the specification may be directly implemented with a hardware module, a software module, or a combination of the hardware module and the software module, which is executed by the processor 910. The software module may reside on a storage medium (i.e., the memory 930 and/or the storage 960) such as a random access memory (RAM), a flash memory, a read only memory (ROM), an erasable programmable ROM (EPROM), an electrically erasable programmable ROM (EEPROM), a register, a hard disk drive, a removable disc, or a compact disc-ROM (CD-ROM). The storage medium may be coupled to the processor 910. The processor 910 may read out information from the storage medium and may write information in the storage medium. Alternatively, the storage medium may be integrated with the processor 910. The processor 910 and the storage medium may be implemented with an application specific integrated circuit (ASIC). The ASIC may be provided in a user terminal. Alternatively, the processor 910 and storage medium may be implemented with separate components in the user terminal.

The above description is merely illustrative of the technical idea of the present disclosure, and various modifications and modifications may be made by one having ordinary skill in the art without departing from the essential characteristic of the present disclosure.

Therefore, the described embodiments of the present disclosure are intended not to limit but to explain the technical idea of the present disclosure. The scope of the technical idea of the present disclosure is not limited by the described embodiment. The scope of protection of the present disclosure should be construed by the following claims, and all equivalents thereof should be construed as being included within the scope of the present disclosure.

Embodiments of the present disclosure provide a battery diagnosing apparatus and method that communicate with BMS to perform cloud-based battery diagnostics.

Embodiments of the present disclosure provide a battery diagnosing apparatus and method that diagnose whether a battery is abnormal, via an auto encoder-based artificial intelligence model.

Embodiments of the present disclosure provide a battery diagnosing apparatus and method that diagnose whether a battery is abnormal, based on an artificial intelligence model in a cloud if the BMS determines that a battery diagnosis is necessary.

In addition, a variety of effects directly or indirectly understood via the present disclosure may be provided.

Hereinabove, although the present disclosure was described with reference to example embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

What is claimed is:

1. A battery diagnosing apparatus comprising:
a communication device configured to receive time-series data associated with a condition of a battery from a vehicle; and
a controller configured to:
divide the time-series data into unit window blocks,
divide time-series data included in respective unit window blocks, among the unit window blocks, into data segments associated with operating states of the vehicle,
input the data segments into an artificial intelligence model trained to classify the data segments as normal or abnormal, and
diagnose whether the battery is abnormal based on classification of the data segments by the artificial intelligence model.

2. The battery diagnosing apparatus of claim 1, wherein each data segment, among the data segments, corresponds to one of a driving state, a state of charge (SOC), or a parking state of the vehicle.

3. The battery diagnosing apparatus of claim 2, wherein the controller is configured to diagnose that the battery is abnormal based on at least one of the data segments being classified as abnormal by the artificial intelligence model.

4. The battery diagnosing apparatus of claim 2, wherein the artificial intelligence model includes an auto-encoder-based model, and
wherein the artificial intelligence model is configured to:
determine a reconstruction error of each of the data segments data that are input to the artificial intelligence model, and
classify a data segment, among the data segments, as abnormal based on determining that the reconstruction error of the data segment exceeds a predetermined reference value.

5. The battery diagnosing apparatus of claim 4, further comprising a learning device configured to train the artificial intelligence model by using data segments, among data segments used as learning data, classified as normal.

6. The battery diagnosing apparatus of claim 5, wherein the learning device is configured to adjust the predetermined reference value based on the reconstruction error of the data segments classified as normal.

7. The battery diagnosing apparatus of claim 5, wherein the learning device is configured to evaluate performance of the artificial intelligence model by using, as verification data, data segments, classified as abnormal among the data segments used as learning data.

8. The battery diagnosing apparatus of claim 7, wherein the learning device is configured to evaluate the performance of the artificial intelligence model by further using a certain ratio of the data segments classified as normal as the verification data.

9. The battery diagnosing apparatus of claim 2, wherein the controller is configured to store classification results of the data segments and a result of evaluating performance of the artificial intelligence model in a database.

10. A battery diagnosing method, the method comprising:
obtaining time-series data associated with a condition of a battery from a vehicle;
dividing the time-series data into unit window blocks;
dividing time-series data included in respective unit window blocks, among the unit window blocks, into data segments associated with operating states of the vehicle;
inputting the data segments into an artificial intelligence model trained to classify the data segments as normal or abnormal; and
diagnosing whether the battery is abnormal based on classification of the data segments by the artificial intelligence model.

11. The method of claim 10, wherein each of the data segments corresponds to one of a driving state, an SOC, or a parking state of the vehicle.

12. The method of claim 10, wherein diagnosing whether the battery is abnormal includes diagnosing that the battery is abnormal based on at least one of the data segments being classified as abnormal by the artificial intelligence model.

13. The method of claim 11, further comprising:
determining a reconstruction error of each of the data segments that is input to the artificial intelligence model; and
classifying a data segment, among the data segments, as abnormal based on determining that the reconstruction error for the data segment exceeds a predetermined reference value.

14. The method of claim 13, further comprising learning the artificial intelligence model by using data segments classified as normal among data segments used as learning data.

15. The method of claim 14, further comprising adjusting the predetermined reference value based on the reconstruction error of the data segments classified as normal.

16. The method of claim 15, further comprising evaluating performance of the artificial intelligence model by using, as verification data, data segments classified as abnormal among the data segments used as learning data.

17. The method of claim 16, wherein evaluating the performance of the artificial intelligence model includes evaluating the performance of the artificial intelligence model by further using, as the verification data, a certain ratio of the data segments classified as normal.

18. The method of claim 11, further comprising storing classification results of the data segments and a result of evaluating performance of the artificial intelligence model in a database.
